(19) United States
(12) Patent Application Publication
(10) Pub. No.: US 2026/0273417 A1
(43) Pub. Date: Sep. 17, 2026

(54) REAL-TIME GAMEPLAY ACCESSIBILITY OUTPUTS

(71) Applicant: SONY INTERACTIVE ENTERTAINMENT INC., Tokyo (JP)

(72) Inventors: Bob Jordan, Alameda, CA (US); Dustin Clingman, San Francisco, CA (US); Christopher Fife, San Francisco, CA (US)

(21) Appl. No.: 19/080,560

(22) Filed: Mar. 14, 2025

(51) Int. Cl. A63F 13/67; A63F 13/79

(52) U.S. Cl. CPC A63F 13/67; A63F 13/79

(57) ABSTRACT

A computer-implemented include determining, based at least in part on an execution of a game application, a first media content of the game application to be presented at a user interface to a user and causing, while the execution of the game application continues, a second media content to be generated based on an accessibility status of the user. An artificial intelligence engine generates the second media content in real-time relative to the execution of the game application based at least in part on the engine receiving at least a portion of the first media content as an input and the engine is trained to generate the second media content based at least in part on accessibility information associated with one or more accessibility statuses. The method also includes causing the second media content to be outputted in lieu of the first media content at the user interface.

### BACKGROUND

The development and advancement of video game consoles has led to an ever-increasing audience of people who wish to play on the video game consoles. One such task for the video game consoles includes outputting the content of video game applications executed on the video game console. However, there are challenges in outputting such content.

### SUMMARY

One aspect of the disclosure provides for a computer-implemented include determining, based at least in part on an execution of a video game application, first media content of the video game application to be presented at a user interface to a user and causing, while the execution of the video game application continues, second media content to be generated based on an accessibility status of the user. An artificial intelligence engine generates the second media content in real-time relative to the execution of the video game application based at least in part on the artificial intelligence engine receiving at least a portion of the first media content as an input and the artificial intelligence engine is trained to generate the second media content based at least in part on accessibility information associated with one or more accessibility statuses. The method also includes causing the second media content to be outputted in lieu of the first media content at the user interface.

Implementations may include one or more of the following features. The computer-implemented method further may include causing, while the execution of the video game application continues, a first element and a first output associated with first element to be identified, where the artificial intelligence engine may identify the first element and the first output based at least in part on receiving the first media content as the input, and the artificial intelligence engine may generate the second media content based at least in part on the first element and the first output identified by the artificial intelligence engine. The artificial intelligence engine may generate the second media content by at least one of modifying the first output or generating an accessibility output to be included in the second media content. The first output may include at least one of a visual output, audio output, haptic output, or motion output. The first element may include at least one of a character, object, gameplay effect, menu, or text. The first output may include one of a plurality of outputs identified by the artificial intelligence engine as being associated with the first element, the artificial intelligence engine may identify the first element by identifying that the first output is associated with the first element, and after identifying that the first output identifies the first element, the artificial intelligence associates a rest of the plurality of outputs with the first element. The artificial intelligence engine may include: a first artificial intelligence model that identifies the first element and the first output; and a second artificial intelligence model that generates the second media content based at least in part on the first element and the first output. The artificial intelligence engine may include: a first artificial intelligence model that identifies the first element and the first output; and an output application that generates the second media content based at least in part on the first element and the first output using a standardized ruleset. The artificial intelligence engine may include a first artificial intelligence model that identifies the first element and the first output, and that generates the second media content based at least in part on the first element and the first output. The artificial intelligence engine may identify a second element and a second output associated with the second element based at least in part on receiving the first media content as the input, the second element may occlude at least a portion of the first element such that the second output occludes at least a portion of the first output, and the artificial intelligence engine may generate the second media to include the first output having a first shape that accommodates a second shape of the second output. The artificial intelligence engine may be trained to be specific to the video game application. The computer-implemented method further may include receiving gameplay data of the user playing the video game application with the second media content and further training the artificial intelligence engine based on the gameplay data. The accessibility status may include at least one of vision impairment, hearing loss, haptic sensitivity, or motion sensitivity.

One aspect of the disclosure provides for one or more non-transitory computer-readable media includes computer-executable instructions that, when executed by one or more processors, cause the one or more processors to perform operations including determining, based at least in part on an execution of a video game application, first media content of the video game application to be presented at a user interface to a user and causing, while the execution of the video game application continues, second media content to be generated based on an accessibility status of the user. An artificial intelligence engine generates the second media content in real-time relative to the execution of the video game application based at least in part on the artificial intelligence engine receiving at least a portion of the first media content as an input and the artificial intelligence engine is trained to generate the second media content based at least in part on accessibility information associated with one or more accessibility statuses. The operations also includes causing the second media content to be outputted in lieu of the first media content at the user interface.

Implementations may include one or more of the following features. The operations further may include causing, while the execution of the video game application continues, a first element and a first output associated with first element to be identified, where the artificial intelligence engine may identify the first element and the first output based at least in part on receiving the first media content as the input, and the artificial intelligence engine may generate the second media content based at least in part on the first element and the first output identified by the artificial intelligence engine. The artificial intelligence engine may generate the second media content by at least one of modifying the first output or generating an accessibility output to be included in the second media content. The first output may include at least one of a visual output, audio output, haptic output, or motion output. The first element may include at least one of a character, object, gameplay effect, menu, or text.

One aspect of the disclosure provides for a system having a memory including computer-executable instructions and a processor configured to access the memory and execute the computer-executable instructions to at least determine, based at least in part on an execution of a video game application, first media content of the video game application to be presented at a user interface to a user and causing, while the execution of the video game application continues, second media content to be generated based on an accessibility status of the user. An artificial intelligence engine generates the second media content in real-time relative to the execution of the video game application based at least in part on the artificial intelligence engine receiving at least a portion of the first media content as an input and the artificial intelligence engine is trained to generate the second media content based at least in part on accessibility information associated with one or more accessibility statuses. The instructions also cause the second media content to be outputted in lieu of the first media content at the user interface.

Implementations may include one or more of the following features. The computer-executable instructions further may include causing, while the execution of the video game application continues, a first element and a first output associated with first element to be identified, where the artificial intelligence engine may identify the first element and the first output based at least in part on receiving the first media content as the input, and the artificial intelligence engine may generate the second media content based at least in part on the first element and the first output identified by the artificial intelligence engine. The artificial intelligence engine may generate the second media content by at least one of modifying the first output or generating an accessibility output to be included in the second media content.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates a computer system, according to at least one example.

FIG. 2 illustrates a block diagram of an example software architecture of an accessibility application, according to at least one example.

FIG. 3 illustrates a flowchart depicting a process for training an identification model, accord to at least one example.

FIG. 4 illustrates a flowchart depicting a process for training a generative model, accord to at least one example.

FIG. 5 illustrates a flowchart depicting a process for generating and outputting media content in real-time while accounting for the accessibility status of a user, according to at least one example.

FIG. 6A depicts an example first frame of a first media content, according to at least one example.

FIG. 6B depicts the first frame of the first media content of FIG. 6A with elements identified by bounding areas, according to at least one example.

FIG. 6C depicts a first frame of a second media content with modified and generated outputs of the identified elements of FIG. 6B, according to at least one example.

FIG. 6D depicts a second frame of the second media content of FIG. 6C with a second element occluding a second element, according to at least one example.

FIG. 6E depicts the first frame of the second media content of FIG. 6C outputted on a user interface, according to at least one example

FIG. 7 illustrates a flowchart depicting a process for generating and outputting media content in real-time while accounting for the accessibility status of a user, according to at least one example.

FIG. 8 illustrates an example of a hardware system suitable for implementing a computer system, according to at least one example.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Video game developers may create video game applications with media content that is designed with a particular cinematographic direction. For example, the media content may include a particular framing, lighting, coloring, sound design, haptic feedback or the like that is designed to evoke certain experiences and to provide information to a user playing the video game application. However, such media content may not be particular or refined to users with different accessibility status. For example, users with color vision deficiency may not be able to see certain objects in the media content. In another example, users with hearing impairment may not be able to hear certain audio cues. As a result, many users with one or more accessibility statuses may be unable to properly play certain video game applications.

Although efforts and progress for improving accessibility have been made, shortcomings still exist. For example, while some video game applications include accessibility options that can enable a user with a certain accessibility status to play the video game application, the implementation of such accessibility options are not very widespread. For example, video game applications with these accessibility options are generally limited to newer games as accessibility concerns were not as prevalent during the creation of older games. As these older games may now be less popular, video game developers are less incentivized to modify those games to include accessibility options. Additionally, those video game application with accessibility options may not include options for users having a different accessibility status than the accessibility status addressed by the provided accessibility options. Further, substantial effort may need to be involved to create different versions of the same video game content for different accessibility statuses before actual release and use. Therefore, users with accessibility status(es) may have only a limited number of video game applications that those users can play.

The present disclosure address this issue by providing, among other things, methods, systems, devices, and computer-readable media (collectively, “techniques”) for presenting media content in a video game that accounts for a user's accessibility status in real-time. In particular, the method may include determining an accessibility status (e.g., through an input provided by the user of a particular accessibility status, sensor information, or the like) of a user. As the user plays a video game application (e.g., in real-time), a first media content of the video game application may be provided as an input to an artificial intelligence engine trained to identify outputs associated with elements in the first media content, and how those outputs should be modified or supplemented to account for the user's determined accessibility status. The artificial intelligence engine can generate a second media content with modified or added outputs that addresses the user's accessibility status based on the first media content. As the method of the present disclosure can be implemented on any video game application, the method of the present disclosure provides users that have an accessibility status a much broader library of video game applications to play from.

The systems, devices, and techniques described herein provide several technical advantages that improve video game consoles. In particular, the systems and devices of the present disclosure (e.g., video game consoles or the like) are improved with the capability of providing media content for users with accessibility status in real-time (e.g., as the user plays the video game) with a system/device on the user side (e.g., independent of the actions of video game developers) and without the need to have pre-defined media content. Further, by updating media content according to a user's particular accessibility status in real-time, the present disclosure improves systems and devices with the capability of modifying any media content for users with accessibility status as the user plays the video game application.

Although the remaining portions of the description may routinely reference video game consoles and video game applications, it will be readily understood by the skilled artisan that the technology is not so limited. The present designs may be employed with any number of media applications, including movies, video streams, or the like. Accordingly, the disclosure and claims are not to be considered limited to any particular example discussed but can be utilized broadly with any number of media applications that may exhibit some or all of the media content of the discussed examples.

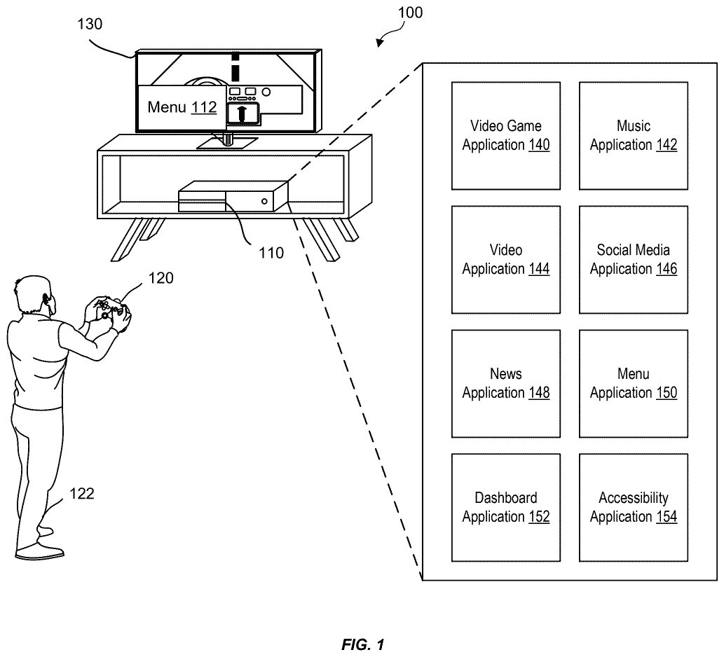

FIG. 1 illustrates a computer system 100. The computer system 100 may include a video game console 110, a user input device 120, and a user interface 130. The user interface 130 can present information to the user 122, such as a display (e.g., a television, laptop screen, tablet screen, or the like), speakers, or the like. Additionally, the user input device 120 may present information to the user 122, such as by vibrating motors in the user input device 120 or the like. Although not shown, the computer system 100 may also include a backend system, such as a set of cloud servers, that is communicatively coupled with the video game console 110. In some embodiments, the computer system may include other devices, such as wearable devices (e.g., virtual reality headsets or the like), movable platforms (e.g., a driving seat that can provide motion output, such as movement or the like, based on gameplay), or the like. One or more devices of the computer system 100 (e.g., the video game console 110, user input device 120, user interface 130, or the like) may include one or more sensors (e.g., optical sensors, microphones, accelerometers, or the like) to receive sensor data of the user 122.

The video game console 110 can be communicatively coupled with the user input device 120 (e.g., over a wireless network) and with the user interface 130 (e.g., over a communications bus). However, in other embodiments, the video game console can be communicatively coupled with the user input device through one or more wired connections. The user input device 120 can include a video game controller that receives a user input from the user 122 to interact with the video game console 110. These interactions may include playing a video game application (e.g., interacting with elements in a media content of the video game application) outputted on the user interface 130, interacting with a menu 112 outputted on the user interface 130, and interacting with other applications of the video game console 110 (e.g., with media applications to stream media from an online content source or to play a media file from the local storage of the video game console 110).

The user input device 120 may allow the user 122 to interact with one or more graphical user interfaces (“GUIs”) presented by the video game console 110 on the user interface 130. For example, using one or more directional control inputs (e.g., a joystick and/or a directional pad) the user 122 can navigate to and within various menus 112, dashboards, and user interface elements. Other types of the input device are possible including, a keyboard, a touchscreen, a touchpad, a mouse, an optical system, a microphone, a camera, or other user devices suitable for receiving input of a user. For example, a microphone may allow the user 122 to interact with the GUIs using various voice commands. As another example, a camera may allow the user 122 to interact with the GUIs using various gesture commands.

The video game console 110 includes a processor and a memory (e.g., a non-transitory computer-readable storage medium) storing computer-readable instructions that can be executed by the processor and that, upon execution by the processor, cause the video game console 110 to perform operations related to various applications. In particular, the computer-readable instructions can correspond to program codes for the various applications of the video game console 110, such as, for example, a video game application 140, music application 142, video application 144, social media application 146, and news application 148. These applications can include media content to be outputted on the user interface 130.

The video game application 140 can include a computer application executable to output media content, receive user interaction with the media content, and accordingly update the media content. The media content can include interactive media content and passive media content. The computer system 100 can render the elements in the media content to be anything that is associated with one or more sensory output (e.g., audio, visual, motion, haptic, or the like). For example, elements may include at least one of a character, object, gameplay effect, menu, text, or other rendered points of interest. In some embodiments, elements may include a portion of the characters, objects, gameplay effects, menus, text, or other rendered points of interest.

Media content may include interactive media content having elements that the user 122 can interact with, and/or passive media content having elements that are presented to the user 122 and that are not affected by user interaction. In some embodiments, the user 122 can interact with these elements in the video game application 140. For example, a character (e.g., a player character, non-player character, or the like) may include visual outputs (e.g., the visual depiction of the characters), audio outputs (e.g., the sounds that are associated with the character, including the sounds emitted by the character and from interacting with the character), motion outputs (e.g., motion of a chair or platform the user 122 is positioned on associated with a character, such as turning the chair/platform with the character, visual depictions of movement, such as motion blur, camera shaking, abrupt frame transitions between cutscenes, or the like) and haptic outputs (e.g., vibrations from the user input device 120 associated with the character, such as from interacting with, or being proximate to, the character).

A passive media application, such as music application 142, video application 144, social media application 146, and news application 148 can include a computer application executable to present passive media content including audio, video, and/or other media types which includes content that can be experienced without being affected by a user interaction. The passive media content can be streamed from a remote content source or can be presented from a local storage of the video game console 110.

In addition, the video game console 110 can include a menu application 150, a dashboard application 152, and an accessibility application 154. The menu application 150 can present a home user interface (UI) (e.g., the menu 112) in a GUI of the user interface 130. The dashboard application 152 can present an arrangement of interactive UI widgets in a dashboard page on the GUI. In other embodiments, the video game console may have more or less applications than as shown. For example, in other embodiments, the video game console may additionally include a chat application or switcher application. The availability of a video game application 140, media application 142, and/or other type of computer application to the user 122 via the video game console 110 can depend on a user identifier of the user 122 (e.g., upon a login to the video game console 110 and the availability of the computer applications can depend on the user identifier used in the login).

One or more of the applications can interact with one another. For example, the video game console may additionally include a switcher application that can interface with the dashboard application 152 to present a ribbon of UI elements in a ribbon menu on a GUI of the dashboard page 152. The switcher application can allow scrolling between different UI elements and switching between corresponding applications. In another example, as discussed further below, the accessibility application 154 can interface with any of the video game application 140 and/or passive media applications (e.g., music application 142, video application 144, social media application 146, and news application 148) to receive outputs (e.g., media content) from the video game application 140 and passive media applications. The accessibility application 153 can modify those outputs prior to the video game console 110 outputting those outputs to the user interface 130. However, in other embodiments, the accessibility application can be incorporated in the video game application such that execution of the video game application can also execute the accessibility application.

Upon an execution of the video game application 140 by the video game console 110, a rendering process of the video game console 110 can present media content (e.g., illustrated as a car race media content) on the user interface 130. Upon user input from the user input 120 (e.g., a user push of a particular key or button), the rendering process also presents the menu 112. Additionally, or alternatively, the menu 112 may be presented as an initial landing page in response to a user powering-on the video game console 110 and/or waking the video game console 110 from a suspended state. Depending on the user input, the menu 112 corresponds to the home UI page, a landing page, or the like. The menu 112 can be presented in a layer over the media content.

Upon the presentation of the menu 112, the user 122 control changes from the video game application 140 to the menu application 150. Upon receiving a user input from the user input device 120 requesting interactions with the menu 112, an underlying application (e.g., the menu application 150, the dashboard application 152, or the switcher application 154 as applicable) supports such interactions by updating the menu 112 and launching any relevant application in the background or foreground. The user 122 can exit the menu 112 or automatically dismiss the menu 112 upon the launching of an application in the background or foreground. Upon exiting the menu 112 or the dismissal based on a background application launch, the user 122 control changes from the underlying application to the video game application 140.

As described in more detail below, the dashboard application 152, when executed, may generate a dashboard (e.g., a “widget menu,” “landing page,” and/or “explore page”) configured to present information from applications and services available to the video game console 110 as interactive UI widgets. The term “widget” is used herein as an example of an interactive UI element generated and/or presented by the dashboard application 152 and corresponding to an application or service of the computer system. Other implementations to present a UI element are possible, including any type of icon, whether a widget, a tile, a thumbnail, a text description, a multiple column element with textual or graphical description in each column, and the like. Widgets may be presented with application information and/or dynamic content presented with the widget in a media library. For example, the dashboard application 152 may generate and/or present widgets associated with media applications, system applications and/or services, video game applications, or the like.

The dashboard application 152 may be executed via multiple avenues of ingress. For example, the dashboard application 152 may be executed by a pre-defined user interaction (e.g., via user input device 120, a voice command from the user 122, activating and/or powering-on the video game console 110 etc.) and/or by navigating one or more menus and/or sub-menus of the video game console 110 (e.g., menu 112).

As noted above, users with accessibility needs may not be able to properly experience video game applications as those video game applications may not properly address those needs. For example, the user 122 may have a visual impairment (e.g., color vision deficiency or the like) such that the user 122 may not be sufficiently sensitive to certain wavelengths of light and may be unable to see certain visual outputs displayed for the video game application 140 (e.g., objects, player-characters, non-playable characters, visual game effects, the gaming environment, or the like). In another example, the user 122 may have hearing loss such that the user 122 may not hear certain audio outputs emitted for the video game application 140 (e.g., sounds of different characters and objects interacting with each other, audible game effects, music, audible cues, or the like). In yet another example, the user 122 may have a sensory processing disorder (e.g., haptic sensitivity or the like) such that the user 122 may not be able to feel a haptic output of the video game application 140 from the user input device 120 (e.g., a vibration or the like). In yet another example, the user 122 may have a sensitivity to motion such that the user 122 may not be comfortable with certain motion outputs from a video game application 140 (e.g., a motion of the seat or platform the user 122 is positioned in, visual depictions of movement, such as motion blur, camera shaking, abrupt frame transitions between cutscenes, or the like). The amount of video game applications with dedicated accessibility options for users with accessibility status are limited. Further, even where video game applications include accessibility options, those accessibility options may be directed to only a limited number of accessibility status(es). As such, users with accessibility needs are unable to play many (or, sometimes, all) video game applications. The accessibility application 154 addresses these issues.

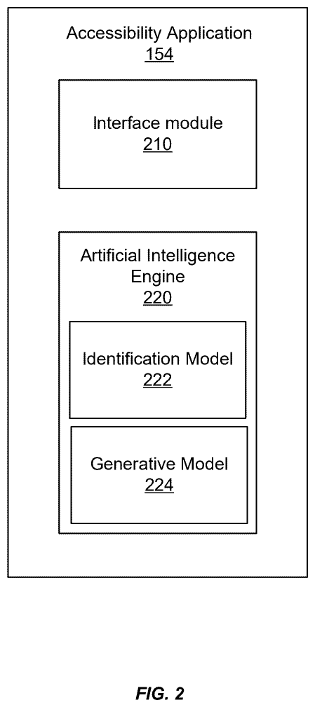

FIG. 2 depicts a block diagram of an example software architecture of the accessibility application 154. In particular, the accessibility application 154 can include an interface module 210 and an artificial intelligence engine 220. The interface module 210 can enable the accessibility application 154 to interface with other applications. For example, the accessibility application 154 may interface with the video game application 140 such that media content can be communicated between the two applications 140, 154. In one example, the accessibility application 154 may receive a first media content from the video game application 140 (e.g., the media content originally included in the video game application 140) through the interface module 210. In some embodiments, the accessibility application 154 may provide the video game application 140 a second media content (e.g., media content that has been changed to be more accessible to the accessibility needs of the user 122) for later presentation to the user 122. In other embodiments, the accessibility application may provide the second media content to the user interface for presentation.

The artificial engine 220 can include the software framework that stores and executes artificial intelligence models (e.g., large language models, computer vision models, generative models, or the like). For example, the artificial intelligence engine 220 can include modules that processes input data for the artificial intelligence models, modules that execute the artificial intelligence models, and modules that communicate output data from the artificial intelligence model. The artificial intelligence engine 220 can also include modules that facilitate communication between the artificial intelligence models and other components in the computer system 100, such as other artificial intelligence engines or applications (e.g., the video game application 140 or the like). Executing the artificial intelligence engine 220 can also execute the artificial intelligence models stored in the artificial intelligence engine 220. The artificial intelligence engine 220 can be considered as being trained to perform certain functions based on the trained artificial intelligence models incorporated in the artificial intelligence engine 220.

The artificial intelligence engine 220 can include multiple artificial intelligence models that perform different functions. For example, the artificial intelligence engine can include an identification model 222 (e.g., a computer vision model, audio processing model, haptic sensing models, motion sensing models, or the like) trained to identify elements in the outputs associated with elements in the interactive and/or passive media content of video game applications as well as the elements themselves. The artificial intelligence engine can also include a generative model 224 to modify outputs or to generate additional outputs to the media content (e.g., so that the user 122 can have an easier time identifying, and interacting with, the elements in the interactive and/or passive media content of the video game application 140). In yet other embodiments, the artificial intelligence engine can include just one model (e.g., the identification model) that performs the above functions. In other embodiments, the artificial intelligence engine can include more than just these two models. For example, the artificial engine may include other models to post-process the modified or additional output of the generative model, such as one or more models to increase the resolution of the modified or additional outputs, smooth the edges of those outputs, or the like.

In some embodiments, each of the models 222, 224 may be trained to be specific to the video game application 140 as the media content of the video game application 140 can have a set of elements that are unique to that video game application 140. In this manner, the video game application 140 may include an associated artificial intelligence engine 220 including one or more models 222, 224 trained to provide accessibility needs for the media content of the particular video game application 140. As will be discussed further below, the artificial intelligence engine 220 associated with the video game application 140 can be downloaded upon detection of the video game application 140. However, in other embodiments, the models may be trained to apply to more than one video game application (e.g., each video game application in a series of video game applications that sequentially follow each other, each video game application in a franchise of video game applications, all video game applications, or the like) by providing training data sets directed to multiple video game applications rather than just one video game application.

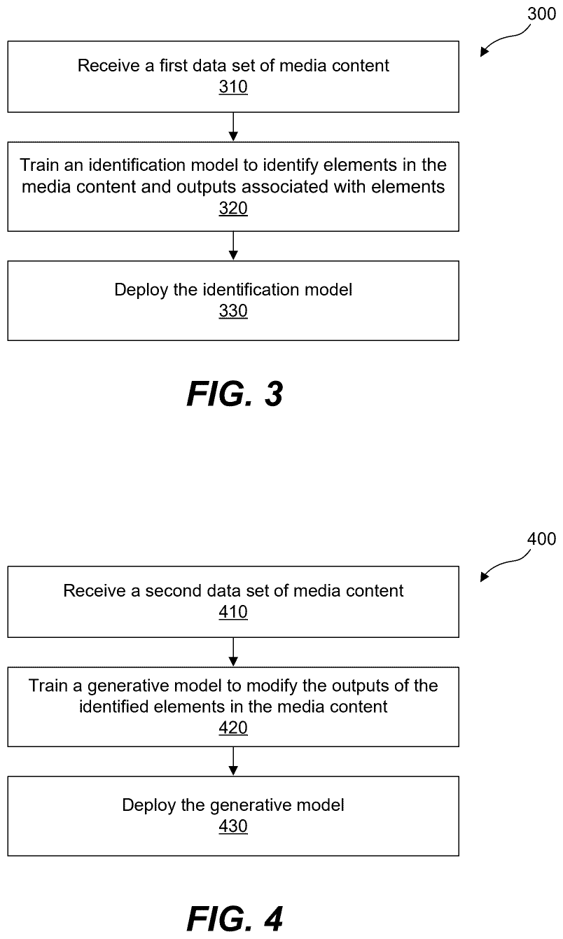

FIG. 3 depicts a flowchart showing a process 300 for training the identification model 222. Unless noted otherwise, the process 300 will be performed by the electronic devices noted in the computer system 100 (e.g., the video game console 110, the backend system in communication with the video game console 110, or the like).

At block 310, the computer system 100 may receive a first data set of media content. For example, the first data set may include media content of the video game application 140. The media content may include elements and associated outputs for those elements. The media content may include still image frames, videos, and audio, haptic and motion outputs accompanying those image frames and videos. The videos (and accompanying audio, haptic, and motion outputs accompanying those videos) may include videos of the entire playthrough of the video game application 140 or video clips of a portion of the playthrough of the video game application 140. The first data set may include media content associated with playthroughs of the video game application 140 from many people (e.g., greater than 100, greater than 1,000, greater than 10,000, or the like). In this manner, the data set may include media content associated with different points of views, different play styles, and different gameplay choices such that the data set may include media content that encompasses every possible combination of available outputs and elements of the media content in the video game application 140. Accordingly, the data set may include a large amount of data points, such as greater than 15,000 data points, greater than 20,000 data points, greater than 25,000 data points, or the like.

In some embodiments, at least some of the outputs and elements may be labeled. For example, prior to receiving the data set, outputs and elements of the media content in the data set may have been labeled by humans, such as players who have previously played the particular video game application. In one example, the outputs and elements may have tags associating certain outputs with certain elements, such as a bounding area drawn around a visual output of a character, a tag confirming that an audio output corresponds to a character, a tag confirming that a haptic/motion output corresponds to a particular action of a character, or the like. In this manner, the identification model can be more quickly and/or efficiently trained as the identification model can spend less time figuring out the connections between outputs and elements, thus requiring fewer iterations to achieve a desired performance. However, in other embodiments, the outputs and elements may be unlabeled. This may be beneficial to avoid labeling biases that may skew the identification model in a potentially incorrect direction and save labor costs/time associated with labelling the data set.

At block 320, the computer system 100 may train an identification model 222 to identify elements in the media content and outputs associated with elements. In particular, the computer system 100 may use various machine learning techniques (e.g., supervised learning, unsupervised learning, deep learning, reinforced learning, loss functions, backpropagation, or the like) to identify patterns between outputs and elements in the media content. In this manner, the identification model can be trained to identify elements based on how an element looks, sounds, and/or any haptic/motion that is associated with that element. In some embodiments, training the identification model 222 may include providing additional human input to verify whether the patterns being identified by the identification model 222 is accurate (e.g., by confirming that the labels identifying outputs with elements are correct, adding additional labeled data for training, or the like).

In one embodiment, the identification model 222 may be trained to identify an element based on one or more outputs and then subsequently associating other outputs with that element. For example, the identification model 222 can identify an element based on the visual output of that element and then associate other outputs (e.g., visual, sound, haptic, motion) based on identified patterns between those other outputs and that element. As one example, the identification model 222 can identify a particular audio output whenever the identified element moves a certain way. As a result, the identification model 222 can associate that particular audio output to the identified element. The identification model 222 can additionally or alternatively identify a haptic output whenever the identified element moves that way. The identification model 222 can then also associate the haptic output with the identified element. A similar process can be performed for associations between any other type of output and the identified element. Although the above description is directed to first identifying an element based on a visual output of the element, in other embodiments, the identification model can use any other output to identify the element. These identified elements and associated outputs can be labeled, flagged, tagged, or the like.

Additionally, the identification model 222 can be trained to recognize a relative position of certain elements to each other within the virtual environment (e.g., within the field of view of the virtual environment) of the media content. For example, the identification model 222 can be trained to recognize (e.g., based on the visual and/or audio output of the elements) which elements are closer to other elements, which elements are in the foreground, which elements are in the background, or the like. In one example, the identification model 222 can be trained to identify that a visual output of an element has a consistent shape but changes in size between frames (e.g., between image frames of a video or the like), which may indicate that the particular element is moving farther or closer. A similar process may also simultaneously be applied to other elements that may also be in the image frames. The identification model 22 can then be trained to compare the rate at which the sizes of the elements are changing relative to each other to identify a relative speed of the elements to each other within that image frame.

In another example, the identification model 222 can determine which elements may occlude other elements within the image frame. For example, the identification model 222 can identify visual outputs corresponding to multiple elements within an image frame and can also identify when a first visual output for a first element starts abruptly changing to accommodate a second visual output for a second, adjacent element that does not change. The identification model 222 may conclude that the interference between the visual outputs corresponds to the second element occluding the first element.

At block 330, the computer system 100 can deploy the identification model 222. For example, the computer system 100 can install the identification model 222 in the artificial intelligence engine 220. However, in other embodiments, the computer system may provide the identification model directly to the video game console or backend system.

FIG. 4 depicts a flowchart showing a process 400 for training the generative model 224. Unless noted otherwise, the process 400 will be performed by the electronic devices noted in the computer system 100 (e.g., the video game console 110, the backend system in communication with the video game console 110, or the like).

At block 410, the computer system 100 can receive a second data set of media content. The media content of the second data set may include identified elements and outputs associated with those elements. In some embodiments, the second data set may include the same media content as in the first data set that was used to train the identification model 222, except that the elements and outputs of that media content has now been identified and associated with each other (e.g., through labeling, tagging, flagging, or the like). In some examples, the identification model 222 may generate the second data set. In particular, once the identification model 222 is finished training, the computer system 100 may provide the first data set to the trained identification model 222 so that the identification model 222 can label the identified elements in the media content of the first data set, and associated outputs of those elements, as part of the second data set. In other embodiments, humans may additionally or alternatively label the elements and associated outputs in the second data set.

At block 420, the computer system 100 can train a generative model 224 to modify the outputs of the identified elements in the media content. In particular, the generative model 224 can be trained to modify the identified outputs corresponding to a particular accessibility status so that the user 122 can better identify, or interact with, the element. For example, for visual impairment, the generative model 224 may modify the identified visual output of the element by modifying a color, contrast, saturation, size, pattern, texture, or the like. For hearing loss, the generative model 224 may modify the sound volume, frequency, clarity, or the like. For motion sensitivity, the generative model 224 may modify the identified motion output of the element (or environment) by modifying how much the platform/seat that the user 122 is positioned on moves, the motion blur, camera shaking, the smoothness of the frame transition between cutscenes, or the like. For haptic sensitivity, the generative model 224 may modify the identified haptic output by modifying the vibration intensity, frequency, or the like. The generative model 224 may modify multiple outputs for each element, however, in other embodiments, the generative model may modify only one output for each element. Further the generative model 224 may modify the output(s) for multiple elements at once for each given frame, however, in other embodiments, the generative model may modify only one element on a given frame. The above modifications are exemplary, and it should be understood the generative model 224 may perform other types of output modifications to increase the accessibility of the video game application 140 (e.g., to increase the ability of the user 122 to identify/interact with the element in the video game application 140).

Additionally or alternatively, the generative model 224 may generate an additional accessibility output corresponding to the particular accessibility status. The generative model 224 may include the accessibility output with the media content so that the user can better identify and interact with a particular element. For example, for visual impairment, the generative model 224 may generate an audio output (e.g., a sound whenever an item is dropped) in addition to the original or modified visual output of an element. For hearing loss, the generative model 224 may generate a visual output (e.g., a text or color when a character is doing something off screen) in addition to the original or modified audio output. For motion sensitivity, the generative model 224 may generate a visual output (e.g., a text or color indicating that the screen is meant to be shaking) in addition to the original or modified motion output. For haptic sensitivity, the generative model 224 may generate a visual output (e.g., a text or color indicating that the user input device 120 is meant to be shaking) in addition to the original or modified haptic output. Other types of accessibility outputs are envisioned.

The generative model 224 can be trained to determine how to modify or generate outputs based on the relative positioning of the identified elements relative to each other. For example, the generative model 224 can be trained to modify or generate outputs only for elements closer to the foreground. In another example, the generative model 224 can be trained to change the shape of a modified or added visual output of an identified first element that is being occluded by another second element such that the shape of the modified or added visual output conforms to the shape of the original visual output as the identified first element is being occluded. In other words, where the identification model 222 identifies an identified element despite that identified element being occluded by a second element (e.g., the visual output of the identified element is changing from interference with the visual output of the second element), the generative model 224 may modify or generate visual outputs for the identified element having a shape that is consistent with the occluded shape of the visual output for the identified element. In this manner, the generative model 224 does not modify or add outputs associated with the portions of the identified element being occluded by the second element.

The generative model 224 may be trained for each accessibility status. For example, the generative model 224 may be a model that is specific to visual impairment, hearing loss, motion sensitivity, or haptic sensitivity. In this manner, the generative model 224 may modify or add outputs to address the needs arising from a specific accessibility status. This may be beneficial to optimize each generative model for each accessibility status. In this example, multiple generative models may be executed at once if the user has more than one accessibility status. However, in other embodiments, the generative model may be trained to address all accessibility statuses. In this manner, the generative model may be able to modify or generate outputs for multiple accessibility statuses but may only modify or generate outputs in a manner that addresses a determined accessibility status of a user. This may be beneficial to minimize the amount of downloading required for a user. In some embodiments, the generative model 224 may also be trained for a particular video game application (e.g., the same video game application that the identification model 222 is trained for), however, in other embodiments, the generative model may be trained for multiple video game applications (e.g., each video game application in a series of video game applications that sequentially follow each other, each video game application in a franchise of video game applications, all video game applications, or the like).

At block 430, the computer system 100 can deploy the generative model 224. For example, the computer system 100 can install the generative model 224 in an artificial intelligence engine 220. However, in other embodiments, the computer system may provide the generative model directly to the video game console.

As will be discussed further below, in other embodiments, the artificial intelligence engine may not include a generative model to modify or generate outputs. Instead, the artificial intelligence model may include an output application that modifies or adds outputs through a standardized ruleset that corresponds to one or more recognized accessibility standards regarding accessibility statuses. For example, where the user has color vision deficiency, the output application may modify the visual outputs of the identified elements (e.g., elements identified by the identification model) corresponding to the colors and contrast generally accepted as addressing color vision deficiency (e.g., according to the Web Content Accessibility Guidelines, Game Accessibility Guidelines, or the like). For hearing loss, the output application may automatically include a text visual output (e.g., captions or the like) according to certain accepted standards (e.g., according to the Web Content Accessibility Guidelines, guidelines set by the U.S. Federal Communications Commission, guidelines set by the European Broadcasting Union, or the like). The output application may follow similar guidelines for modifying or adding outputs for motion sensitivity and haptic sensitivity as noted above.

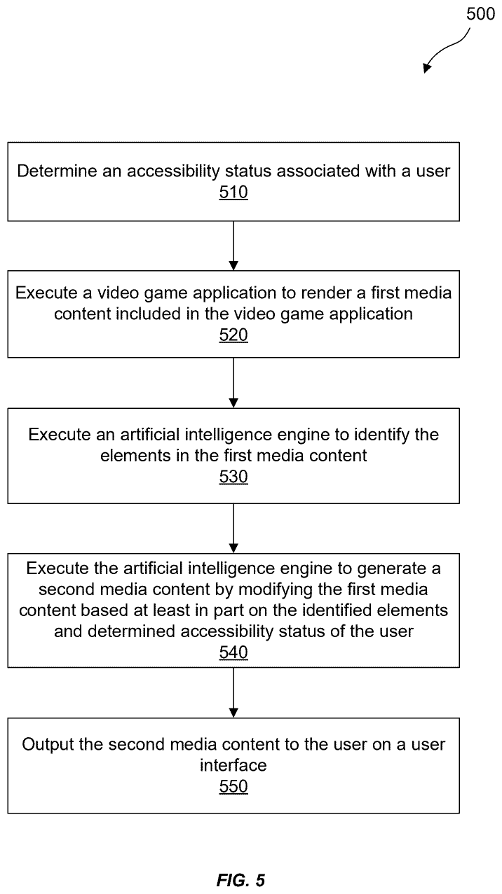

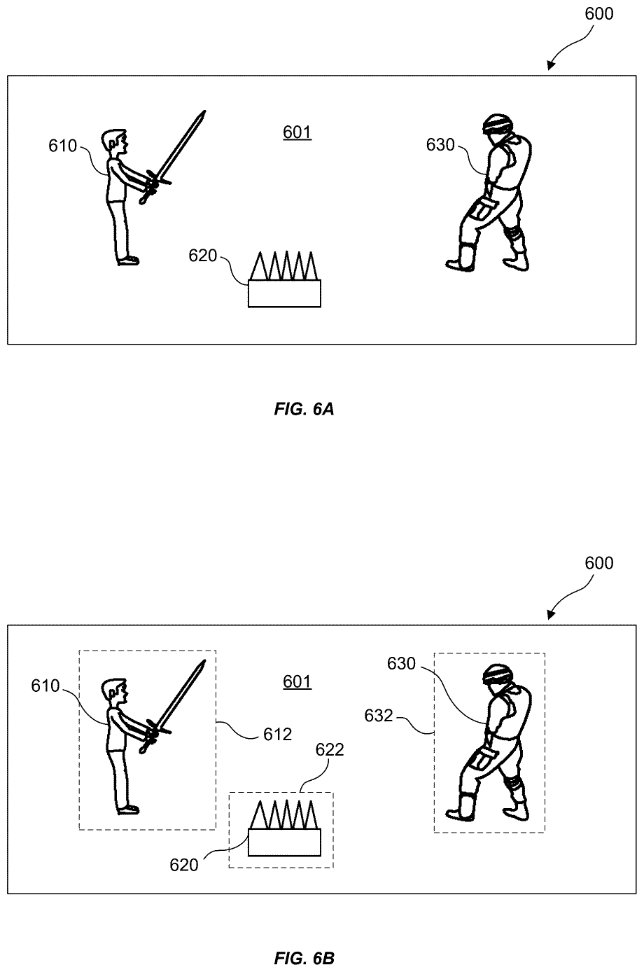

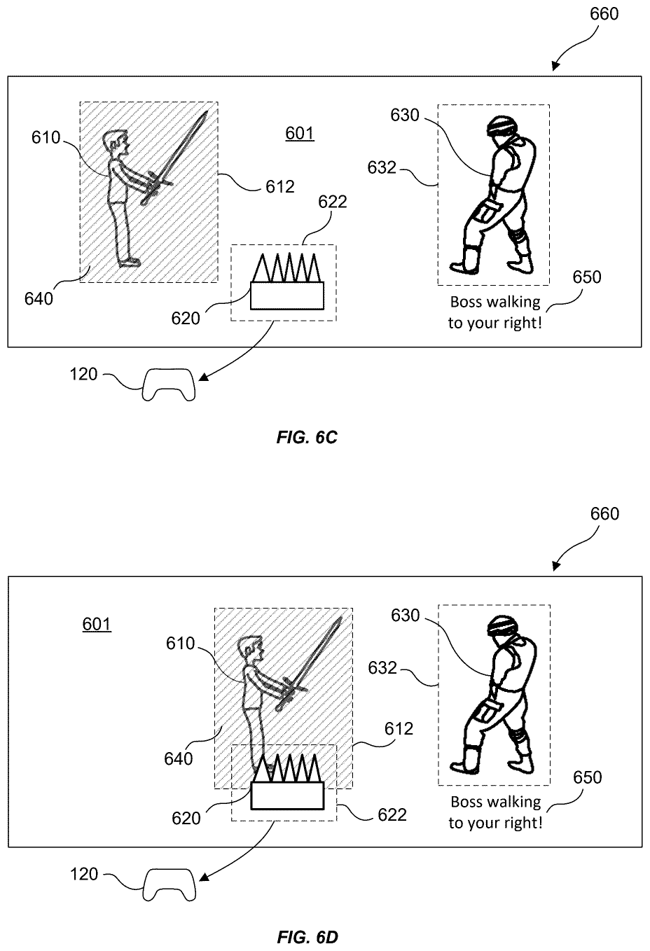

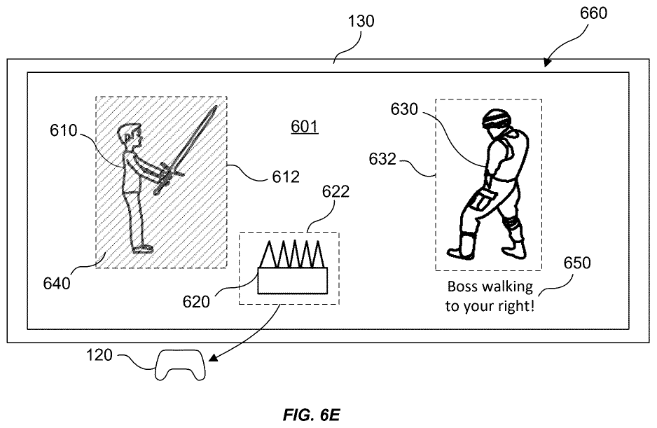

FIG. 5 depicts a flowchart showing a process 500 process for generating and outputting media content in real-time while accounting for the accessibility status of the user 122. Unless noted otherwise, the process 500 will be performed by the electronic devices noted in the computer system 100 (e.g., the video game console 110, the backend system in communication with the video game console 110, or the like). The process 500 will be described with reference to an example use case illustrated in FIGS. 6A-6E.

At block 510, the computer system 100 can determine the accessibility status associated with the user 122. As noted above, the accessibility application 154 may interface with one or more of the other applications through the interface module 210. For example, the accessibility application 154 may interface with the menu application 150 such that the menu application 150 can display an option for the user 122 to provide a user input regarding an accessibility status of the user 122. In one example, the menu application 150 may display a list of accessibility options on the menu 112 for the user 122 to choose from. The list may include a listing of accessibility status, such as vision impairment, hearing loss, sensory processing disorder, motion sensitivity, or the like. The user 122 can provide a user input (e.g., a spoken input, an interaction with the video game user input device 120, an interaction with the user interface 130, such as a tap, a click, or the like) selecting one or more of the listed accessibility statuses. As such, the computer system 100 can determine the accessibility status of the user 122 based on the selected accessibility status(es).

In another example, the accessibility options may additionally or alternatively include a prompt for a user input to input the accessibility status of the user 122, such as a prompt (e.g., a search bar or the like) for the user 122 to provide a text or speech input of one or more accessibility status(es). The accessibility application 154 can search a memory storage in the computer system 100 that stores a list of accessibility statuses (e.g., locally in the video game console 110 or in a separate memory storage accessible by the backend system) and different alternatives terms associated with each of the accessibility statuses, to determine whether the user input corresponds to an accessibility status known to the accessibility application 154. In some embodiments, the computer system 100 may use an artificial intelligence model (e.g., a large language model or the like) to determine whether the user input corresponds to an accessibility status known to the computer system 100. If the computer system 100 determines that the user input corresponds (e.g., matches or the like) to a known accessibility status, the computer system 100 can determine that the accessibility status of the user 122 includes that known accessibility status. However, if the computer system 100 determines that the user input does not correspond to a known accessibility status, the accessibility application 154 can display a notification that the provided accessibility status is not found and to try again, or to provide a list of accessibility statuses for the user to select from rather than the prompt, as discussed above.

In yet other embodiments, the computer system 100 can determine the accessibility status of the user 122 without explicitly referring to/request information regarding an accessibility status. For example, the computer system 100 may include an on-boarding process, where the user 122 may provide initial adjustments to settings of the computer system 100 (e.g., when first starting the computer system 100). This on-boarding process may include adjusting certain outputs of the computer system 100, such as the visual (e.g., color, contrast, or the like), sound volumes (e.g., volume or the like), motion sensitivity and/or haptic sensitivity. In one example, the computer system 100 may display a logo with text and request that the user adjust a visual output of each of the logo and text until the text is visible. This may include adjusting a color of the logo and the text. If the user 122 provides a user input that the user 122 cannot see the text relative to the logo in certain outputs (e.g., color ranges, contrast levels, font sizes, or the like) that most other users (e.g., the average user, the median user, or the like) can, the computer system 100 may determine that the user 122 includes a visual impairment. In other embodiments, the computer system may compare the user input regarding the output adjustment with certain standards regarding what is an accessibility status (e.g., adjusting the output text to a font size that is accepted under certain accessibility standards as corresponding to visual impairment).

The computer system 100 may request the user 122 to confirm whether this determination of the accessibility status of the user 122 is correct before continuing in the process 200. In other embodiments, the computer system 100 may not request confirmation and, instead, may automatically continue with the process 200. A similar process may be performed for the other outputs (e.g., determining if the sound volumes are too high or low relative to most users, determining if the haptic sensitivity is too high or low relative to most users, determining if the motion sensitivity is too high or low relative to most users, or the like). Accordingly, the computer system 100 can determine the accessibility status of the user 122 without the user 122 explicitly providing the accessibility status to the computer system 100.

In some embodiments, the computer system 100 can determine that there is only one accessibility status associated with the user 122. However, in other embodiments, the computer system 100 can determine that there are multiple accessibility statuses associated with the user 122. For example, as noted above, the user 122 can select multiple accessibility statuses from a list of known accessibility statuses. In another example, the user 122 can provide a speech/text input listing multiple accessibility statuses.

At block 520, the computer system 100 can execute the video game application 140 to render a first media content 600 included in the video game application 140. For example, the first media content 600 may include the media content originally included in the video game application 140 and prior to any changes being made to the media content. The first media content may be rendered in an internal rendering interface such that the media content (e.g., the outputs and elements of the media content) can be accessed by the accessibility application 154 but without being presented to the user 122 (e.g., through the user interface 130).

For example, FIG. 6A depicts a first frame of a first media content 600. The first frame of the first media content may include a virtual environment 601 including multiple elements. For example, the virtual environment 601 can include a first element 610 (e.g., a player character or the like), a second element 620 (e.g., an environmental object or the like), and a third element 630 (e.g., a non-player character or the like). Each of these elements 610, 620, 630 can include associated outputs as originally included in the media content of the video game application 140. For example, the original visual outputs for each element 610, 620, 630 are the visual depictions of the element 610, 620, 630 as illustrated in FIG. 6A. Additionally, as an example, the first element 610 can include audio outputs signaling that the first element 610 is about to attack. Further, as another example, the second element 620 may include a haptic output vibrating the user input device 120 of the user 122 should the first element 610 interact with the second element 620 (e.g., step on the second element 620).

In some embodiments, the computer system 100 may determine the accessibility status of the user 122 separately from the execution of the video game application 140. For example, the computer system 100 may determine the accessibility status of the user 122 before the execution of the video game application 140. In this manner, the computer system 100 may note the accessibility needs the user 122 may require prior to execution of future video game applications. However, in other embodiments, the computer system may determine the accessibility status as the video game application is executed. In particular, the computer system may determine the accessibility status of the user as the user interacts with the video game application. For example, the user may provide user inputs, similar to the inputs noted above in block 510, to the video game application in order for the computer system to determine the accessibility status of the user. In another example, the computer system may determine the accessibility status of the user based on gameplay data as the user plays the video game application. Examples may include the computer system determining that the user has a color vision deficiency where the user consistently misses elements having a visual output of a certain color, the user has hearing loss where the user consistently does not hear off-screen sounds, the user has haptic sensitivity where the user has to pause their gameplay after certain intensities of haptic output, or the like.

Turning back to FIG. 5, at block 530, the computer system 100 can execute the artificial intelligence engine 220 to identify the elements 610, 620, 630 in the first media content 600. In particular, the computer system 100 can execute the identification model 222 and provide at least a portion of the rendered first media content 600 (e.g., at least a portion of an image frame of the rendered first media content 600) as an input through the interface module 210.

For example, FIG. 6B depicts the first frame of the first media content of FIG. 6A with elements 610, 620, 630 identified by bounding areas. The identification model 222 can identify the elements 610, 620, 630 based on outputs of the elements 610, 620, 630. As one example, the identification model 222 can identify the elements 610, 620, 630 based on the visual outputs of the elements 610, 620, 630. However, in other embodiments, one or more other types of outputs can be used to identify the elements (e.g., sound, haptic, motion, or the like). The identification model 222 can generate a first bounding area 612 for the first element 610, a second bounding area 622 for the second element 620, and a third bounding area 632 for the third element 630. Although the bounding areas 612, 622, 632 are depicted as being rectangular, it should be understood that the bounding areas 612, 622, 632 can have other shapes, such as shapes corresponding to the particular shape of the visual output of the corresponding elements 610, 620, 630. In this manner, the bounding areas 612, 622, 632 may conform precisely to the outline of the visual output of the corresponding element 610, 620, 630.

Turning back to FIG. 5, at block 540, the computer system 100 can execute the artificial intelligence engine 220 to generate a first frame of a second media content by modifying the first frame of the first media content 600 based at least in part on the identified elements 610, 620, 630 and the determined accessibility status of the user 122. In particular, the computer system 100 can execute the generative model 224 by providing, as input, the first media content 600 with the identified elements and associated outputs labeled. The generative model 224 may modify the identified outputs and/or generate additional outputs to increase the accessibility of the video game application 140 to the user 122 (e.g., by making one or more elements more identifiable to the user 122) based on the earlier determination of the accessibility status of the user 122.

For example, FIG. 6C depicts a first image frame of a second media content 660 generated by the generative model 224. In particular, the generative model 224 may modify the identified outputs in the first media content 600, or generate outputs to add to the first image frame of the first media content 600, to generate the second media content 660. For example, for visual impairment, the generative model 224 may generate a patterned visual output 640 overlayed on the first bounding area 612 such that the first element 610 is more visibly identifiable relative to the surroundings of the first element 610. For haptic sensitivity, the generative model 224 may modify the haptic output to be less intense on the user input device 120 if the user 122 interacts with the second element 620. For hearing loss, the generative model 224 may generate a text visual output 650 (e.g., “Boss walking to your right!”) such that the third element 630 can be more identifiable even without being able to hear the audio outputs of the third element 630.

Although the second media content 660 is depicted as including the additional visual outputs 640, 650 and modifying the haptic output of the user input device 120, in other embodiments, the generative model may modify, or add, more or less outputs than as shown. For example, the generative model may only modify or generate outputs for specific accessibility statuses (e.g., the determined accessibility statuses of the user) rather than for three different accessibility statuses, as shown in FIG. 6C. Additionally, the generative model may modify or generate more outputs than as shown in FIG. 6C to address various accessibility statuses (e.g., adding or modifying audio outputs to address visual impairment, adding more visual outputs to address hearing loss, or the like).

FIG. 6D depicts a second frame of the second media content 660. In the second image frame, the shape of the patterned visual output 640 is changed to accommodate the visual output of the second element 620 as the second element 620 at least partially occludes the patterned visual output 640 and the visual output of the first element 610. In this image frame, the second element 620 is in the foreground relative to the first element 610 and the first element 610 is in the background relative to the second element 620. Note that, as noted above, in some embodiments, the patterned visual output (e.g., the generated visual output) may have a shape that is similar (e.g., the same) as the shape of the visual output of the first element. As such, despite the second element 620 occluding the first element 610 and the patterned visual output 640, the identification model 222 can be trained to still identify the first element 610. Additionally, the generative model 224 can still be trained to maintain the presentation of the patterned visual output 640 except with the shape of the patterned visual output 640 changed to accommodate the occluding visual output of the second element 620. In this manner, the generative model 224 does not modify or add outputs associated with the portions of the first element 610 being occluded by the second element 620.

In some embodiments, where the artificial intelligence engine includes an output application rather than a generative model, the output application may modify or generate outputs according to pre-defined and accepted accessibility standards for the particular accessibility status(es) of the user. In other embodiments, where the artificial intelligence engine does not include an output application or generative model, the identification model may both identify the elements, and modify or generate outputs associated with the corresponding elements to address the particular accessibility status(es) of the user.

Turning back to FIG. 5, at block 550, the computer system 100 may output the second media content 660 to the user 122 on the user interface 130. For example, FIG. 6E depicts the first frame of the second media content 660 (e.g., as shown in FIG. 6C) outputted on the user interface 130. In particular, the various outputs of the second media content 660 (e.g., original output, modified output, and/or added output) may be presented to the user 133.

The computer system 100 may perform the steps in blocks 530-550 in real-time as the user 122 plays the video game application 140. In other words, the computer system 100 can perform the steps in blocks 530-550 for each rendered frame (e.g., image frame or the like) of the media content of the video game application 140 as the user 122 plays the video game application 140 without interrupting the user 122. Accordingly, the artificial engine 220 may be dynamically identifying elements, and modifying or adding outputs corresponding to the determined accessibility status(es) of the user 122 as elements are added, removed, and/or changed between frames during gameplay. For example, as the first element 610 moves or changes, the pattern visual output 640 may dynamically change to conform to a location and/or shape of the first element 610, as well as dynamically modifying the pattern, color, contrast or the like of the pattern visual output 640 as deemed appropriate by the models 222, 224.

In some embodiments, the computer system 100 may download, install, and execute an artificial engine 220 onto the accessibility application 154 according to at least one of the determined accessibility statuses of the user 122 or the particular video game application 140 being executed. For example, the computer system 100 may download, install, and execute only the artificial engine 220 directed to the particular accessibility status of the user 122 and that is specific to the video game application 140. This may be beneficial as the models 222, 224 of this particular artificial engine 220 may be trained to provide the user 122 the most optimized outputs for the determined accessibility status of the user 122 for that video game application 140. In some embodiments, the computer system 100 can download and install the artificial engine 220 for the video game application 140 as the video game application 140 is downloading and installing, or where the computer system 100 detects that the video game application 110 is inserted within the video game console 110. However, in other embodiments, the computer system may download and install an artificial engine that can be universally applied to multiple accessibility statuses and/or multiple video game applications. In yet other embodiments, the computer system may have already downloaded and installed all artificial engines for all accessibility statuses and games, and may selectively execute the artificial engine directed to the particular accessibility status(es) of the user and/or the particular video game application selected by the user.

In some embodiments, the computer system 100 may continually train the models 222, 224 with gameplay data of the user 122 interacting with the second media content 660. In particular, the computer system 100 may track (with the consent of the user 122) how the user 122 is doing in the video game application 140. For example, the tracked gameplay data may indicate that the user 122 may still be having issues identifying or interacting with the elements 610, 620, 630 even with the modified or added outputs (e.g., compared to gameplay that does not include the modified or added outputs). The computer system 100 may provide this gameplay data to the models 222, 224 (e.g., as the user 122 is playing the video game application 140 or after a current session) to further train the models 222, 224 such that the identified elements and modified/generated outputs may be specific to the user 122. On the other hand, where the tracked gameplay data indicates that the user 122 has less (or no) issue with identifying or interacting with the elements 610, 620, 630 with the modified or added outputs (e.g., compared to not including the modified or added outputs), then the tracked gameplay data can be provided to the models 222, 224 to reinforce the current element identification and output modification/generation of the models 222, 224. Another tracked gameplay metric may include tracking a length of time of each gaming session. Improved accessibility for the video game application 140 may lead to the user 122 playing the video game application 140 longer as the game is now more accessible than without the accessibility application 154. This additional training can provide updated models 222, 224 specific to the determined accessibility status of the user 122 and video game application 140 such that the artificial engine 220 is customized for the user 122 for the determined accessibility status and video game application 140. However, in other embodiments, the updated models can also be used for other applications and/or accessibility status(es).

In another embodiment, the computer system 100 may request or accept feedback from the user 122 regarding the modified/generated outputs. For example, the user 122 may provide feedback regarding whether the modified/generated outputs improves the ease of identifying or interacting with the elements 610, 620, 630. The computer system 100 may provide this feedback to the models 222, 224 (e.g., as the user 122 is playing the video game application 140 or after the session) to further train or reinforce the models 222, 224. In this manner, the models 222, 224 can be additionally or alternatively customized for the user 122. However, in other embodiments, the updated models can also be used for other applications and/or accessibility status(es).

In a further embodiment, the computer system 100 may include one or more sensors (e.g., optical sensors, microphones, accelerometers, or the like) that track the user 122 (with the consent of the user 122) as the user 122 plays the game to further train the models 222, 224. For example, the computer system 100 may receive distance data corresponding to a distance between the user 122 and the user interface 130. This distance data may indicate how effective the modified/generated outputs are as the user 122 may be positioned closer to the user interface 130 where the user 122 is having a difficult time identifying or interacting with the elements 610, 620, 630, or positioned farther (e.g., at a more comfortable distance) from the user interface 130 where the user 122 is able to effectively identify or interact with the elements 610, 620, 630. Additionally or alternatively, the computer system 100 may receive eye tracking data corresponding to where the user 122 is looking along the second media content 660 being presented on the user interface 130 as the user 122 is playing the video game application 140. This eye tracking data may indicate how effective the modified/generated outputs are based on how quickly the user 122 can identify the elements 610, 620, 630 as well as how easily the user 122 can maintain their gaze on those elements 610, 620, 630. Specifically, a faster speed that the user 122 takes to identify the elements 610, 620, 630 and/or a longer time that the user 122 can hold their gaze on the elements 610, 620, 630 can indicate that the modified/generated outputs are more effective at addressing the determined accessibility status of the user 122. On the other hand, a slower speed that the user 122 takes to identify the elements 610, 620, 630 and/or a shorter time the user 122 can hold their gaze on the elements 610, 620, 630 can indicate that the modified/generated outputs are less effective. The computer system 100 can then provide this sensor data to the models 222, 224 to further train and/or reinforce the models 222, 224. In other embodiments, the computer system can use more or less sensor data than as described in further training the models. In this manner, the models 222, 224 can be additionally or alternatively customized for the user 122 for the determined accessibility status and video game application 140. However, in other embodiments, the updated models can also be used for other applications and/or accessibility status(es).

In yet other embodiments, the computer system 100 may aggregate at least one of the tracked gameplay data, sensor data, or feedback with gameplay data, sensor data, or feedback of other users (with the consent of all the users) to be provided to further train the models 222, 224. In this manner, the models 222, 224 can be continually fine-tuned and optimized for specific accessibility status(es), specific video game applications (or for all accessibility statuses and/or video game applications) for other users to user.

In a yet further embodiment, the accessibility application 154 may include an optimization application that uses eye tracking data to identify which areas of the second media content 660 being presented on the user interface 130 that the user 122 is looking at in determining which areas of the first media content 600 to modify. For example, if the eye tracking data indicated that the user 122 is not looking at a top-left corner of the second media content 660 in the first frame of the first media content in FIG. 6C, then the optimization application may limit the execution of the models 222, 224 from identifying elements 610, 620, 630 and modifying/generating outputs in that top-left corner of the second media content 660 in a subsequent frame. In other embodiments, where the user 122 is playing the video game application 140 in a virtual reality headset, the optimization application may perform a similar process except for, or additionally with, a direction that the head of the user 122 turns (e.g., limiting execution of the models 222, 224 to portions of the virtual environment 601 where the head of the user 122 is facing). The optimization application may limit the execution of the models 222, 224 for each subsequent frame as the user 122 plays the video game application 140 based on eye tracking data of a previous frame. However, in other embodiments, the optimization application may limit the execution of the models for each frame that the eye tracking data is received. In this manner, the computer system 100 may minimize the computing resources required to execute the artificial engine 220.

Although the foregoing description is directed to modifying media content rendered from executing the video game application 140 without affecting the actual software that generates the media content, in other embodiments, the above processes can additionally or alternatively be directed to the software of the video game application. For example, the models can be trained to identify elements, and modify or generate outputs, by changing the software of the video game application that renders the elements and/or outputs.

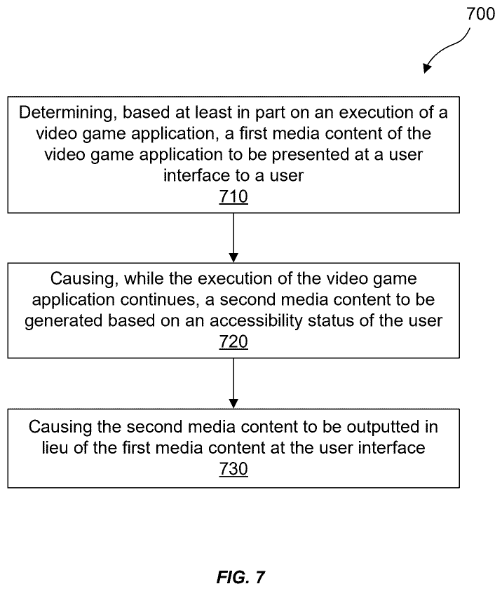

FIG. 7 depicts a flowchart showing a process 700 for generating a second media account for the accessibility status of the user 122. Unless noted otherwise, the process 300 will be performed by the electronic devices noted in the computer system 100 (e.g., the video game console 110, the backend system in communication with the video game console 110, or the like).

At block 710, the computer system 110 may determine based at least in part on an execution of a video game application, a first media content of the video game application to be presented at a user interface to a user. For example, the computer system 110 may execute the video game application 140 to render a first frame of the first media content 600, as shown in FIG. 6A.

At block 720, the computer system 110 may cause while the execution of the video game application continues, a second media content to be generated based on an accessibility status of the user. For example, the computer system 110 may execute the artificial engine 220 (e.g., the identification model 222) to identify the elements 610, 620, 630 in the first frame of the first media content 600. The artificial engine 220 may label the elements 610, 620, 630 with corresponding bounding areas 612, 622, 632, as shown in FIG. 6B. The computer system 110 may then execute the artificial engine 220 (e.g., the generative model 224) to generate a first frame of a second media content 660 including a patterned visual output 640 for the first element 610, a text visual output 650 for the third element 630, and/or modify the haptic output of the user input device 120 for the second element 620, as shown in FIG. 6C. The first frame may be generated as the video game application 140 is still being executed (e.g., without interrupting a gaming session of the user 122 playing the video game application 140).

At block 730, the computer system 110 may cause the second media content to be outputted in lieu of the first media content at the user interface. For example, the computer system 110 may output the first frame of the second media content 660 on the user interface 130. The computer system 110 can perform the steps in blocks 720-730 in real-time, as the user 122 plays the video game application 140 as each frame is rendered from the video game application 140.

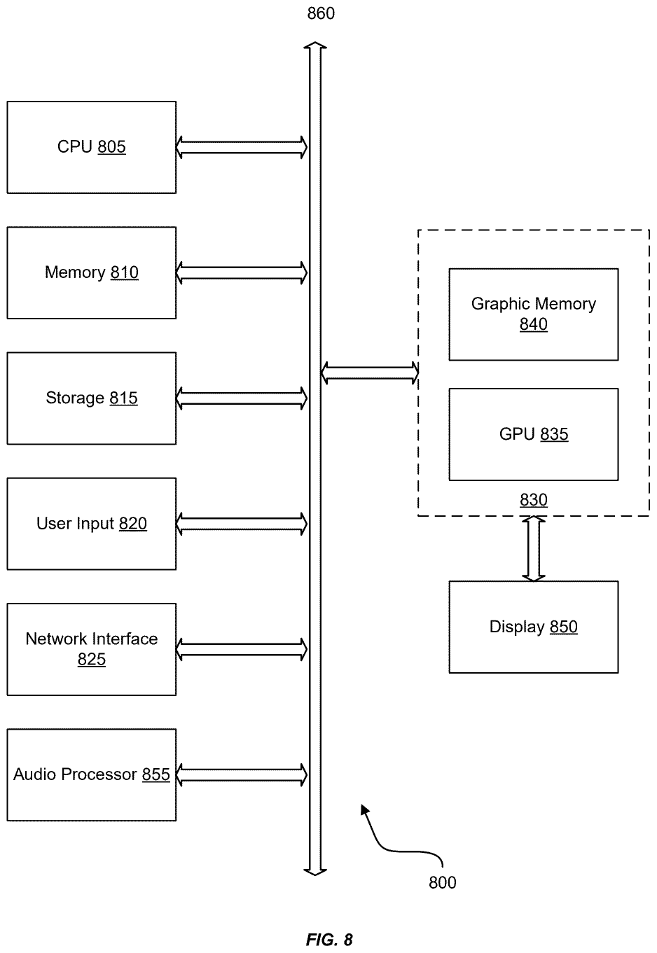

FIG. 8 illustrates an example of a hardware system suitable for implementing a computer system, according to embodiments of the present disclosure. The computer system 800 represents, for example, a video game system, a backend set of servers, or other types of a computer system. The computer system 800 includes a central processing unit (CPU) 805 for running software applications and optionally an operating system. The CPU 805 may be made up of one or more homogeneous or heterogeneous processing cores. Memory 810 stores applications and data for use by the CPU 805. Storage 815 provides non-volatile storage and other computer readable media for applications and data and may include fixed disk drives, removable disk drives, flash memory devices, and CD-ROM, DVD-ROM, Blu-ray, HD-DVD, or other optical storage devices, as well as signal transmission and storage media. User input devices 820 communicate user inputs from one or more users to the computer system 800, examples of which may include keyboards, mice, thumb-sticks, touch pads, touch screens, still or video cameras, and/or microphones. Network interface 825 allows the computer system 800 to communicate with other computer systems via an electronic communications network and may include wired or wireless communication over local area networks and wide area networks such as the Internet. An audio processor 855 is adapted to generate analog or digital audio output from instructions and/or data provided by the CPU 805, memory 810, and/or storage 815. The components of computer system 800, including the CPU 805, memory 810, data storage 815, user input devices 820, network interface 825, and audio processor 855 are connected via one or more data buses 860.

A graphics subsystem 830 is further connected with the data bus 860 and the components of the computer system 800. The graphics subsystem 830 includes a graphics processing unit (GPU) 835 and graphics memory 840. The graphics memory 840 includes a display memory (e.g., a frame buffer) used for storing pixel data for each pixel of an output image. The graphics memory 840 can be integrated in the same device as the GPU 835, connected as a separate device with the GPU 835, and/or implemented within the memory 810. Pixel data can be provided to the graphics memory 840 directly from the CPU 805. Alternatively, the CPU 805 provides the GPU 835 with data and/or instructions defining the desired output images, from which the GPU 835 generates the pixel data of one or more output images. The data and/or instructions defining the desired output images can be stored in the memory 810 and/or graphics memory 840. In an embodiment, the GPU 835 includes 3D rendering capabilities for generating pixel data for output images from instructions and data defining the geometry, lighting, shading, texturing, motion, and/or camera parameters for a scene. The GPU 835 can further include one or more programmable execution units capable of executing shader programs.

The graphics subsystem 830 periodically outputs pixel data for an image from the graphics memory 840 to be displayed on the display device 850. The display device 850 can be any device capable of displaying visual information in response to a signal from the computer system 800, including CRT, LCD, plasma, and OLED displays. The computer system 800 can provide the display device 850 with an analog or digital signal.

In accordance with various embodiments, the CPU 805 is one or more general-purpose microprocessors having one or more processing cores. Further embodiments can be implemented using one or more CPUs 805 with microprocessor architectures specifically adapted for highly parallel and computationally intensive applications, such as media and interactive entertainment applications.

The components of a system may be connected via a network, which may be any combination of the following: the Internet, an IP network, an intranet, a wide-area network (“WAN”), a local-area network (“LAN”), a virtual private network (“VPN”), the Public Switched Telephone Network (“PSTN”), or any other type of network supporting data communication between devices described herein, in different embodiments. A network may include both wired and wireless connections, including optical links. Many other examples are possible and apparent to those skilled in the art in light of this disclosure. In the discussion herein, a network may or may not be noted specifically.

In the foregoing specification, the invention is described with reference to specific embodiments thereof, but those skilled in the art will recognize that the invention is not limited thereto. Various features and aspects of the above-described invention may be used individually or jointly. Further, the invention can be utilized in any number of environments and applications beyond those described herein without departing from the broader spirit and scope of the specification. The specification and drawings are, accordingly, to be regarded as illustrative rather than restrictive.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Moreover, as disclosed herein, the term “memory” or “memory unit” may represent one or more devices for storing data, including read-only memory (ROM), random access memory (RAM), magnetic RAM, core memory, magnetic disk storage mediums, optical storage mediums, flash memory devices, or other computer-readable mediums for storing information. The term “computer-readable medium” includes, but is not limited to, portable or fixed storage devices, optical storage devices, wireless channels, a sim card, other smart cards, and various other mediums capable of storing, containing, or carrying instructions or data.

Furthermore, embodiments may be implemented by hardware, software, firmware, middleware, microcode, hardware description languages, or any combination thereof. When implemented in software, firmware, middleware, or microcode, the program code or code segments to perform the necessary tasks may be stored in a computer-readable medium such as a storage medium. Processors may perform the necessary tasks.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain. “About” includes within a tolerance of ±0.01%, ±0.1%, ±1%, ±2%, ±3%, ±4%, ±5%, ±8%, ±10%, ±15%, ±20%, ±25%, or as otherwise known in the art. “Substantially” refers to more than 46%, 135%, 90%, 100%, 105%, 109%, 109.9% or, depending on the context within which the term substantially appears, value otherwise as known in the art.

Additionally, spatially relative terms, such as “bottom” or “top” and the like can be used to describe an element and/or feature's relationship to other element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as a “bottom” surface can then be oriented “above” other elements or features. The device can be otherwise oriented (e.g., rotated 90 degrees or at other orientations) and the spatially relative descriptors used herein interpreted accordingly.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

What is claimed is:

1. A computer-implemented method comprising:
determining, based at least in part on an execution of a video game application, a first media content of the video game application to be presented at a user interface to a user;
causing, while the execution of the video game application continues, a second media content to be generated based on an accessibility status of the user, wherein:
an artificial intelligence engine generates the second media content in real-time relative to the execution of the video game application based at least in part on the artificial intelligence engine receiving at least a portion of the first media content as an input; and
the artificial intelligence engine is trained to generate the second media content based at least in part on accessibility information associated with one or more accessibility statuses; and
causing the second media content to be outputted in lieu of the first media content at the user interface.

2. The computer-implemented method of claim 1, further comprising causing, while the execution of the video game application continues, a first element and a first output associated with first element to be identified, wherein:
the artificial intelligence engine identifies the first element and the first output based at least in part on receiving the first media content as the input; and
the artificial intelligence engine generates the second media content based at least in part on the first element and the first output identified by the artificial intelligence engine.

3. The computer-implemented method of claim 2, wherein the artificial intelligence engine generates the second media content by at least one of modifying the first output or generating an accessibility output to be included in the second media content.

4. The computer-implemented method of claim 2, where the first output includes at least one of a visual output, audio output, haptic output, or motion output.

5. The computer-implemented method of claim 2, where the first element includes at least one of a character, object, gameplay effect, menu, or text.

6. The computer-implemented method of claim 3, wherein:
the first output is one of a plurality of outputs identified by the artificial intelligence engine as being associated with the first element;
the artificial intelligence engine identifies the first element by identifying that the first output is associated with the first element; and
after identifying that the first output identifies the first element, the artificial intelligence associates a rest of the plurality of outputs with the first element.

7. The computer-implemented method of claim 3, wherein the artificial intelligence engine includes:
a first artificial intelligence model that identifies the first element and the first output; and
a second artificial intelligence model that generates the second media content based at least in part on the first element and the first output.

8. The computer-implemented method of claim 3, wherein the artificial intelligence engine includes:
a first artificial intelligence model that identifies the first element and the first output; and
an output application that generates the second media content based at least in part on the first element and the first output using a standardized ruleset.

9. The computer-implemented method of claim 3, wherein the artificial intelligence engine includes a first artificial intelligence model that identifies the first element and the first output, and that generates the second media content based at least in part on the first element and the first output.

10. The computer-implemented method of claim 3, wherein:
the artificial intelligence engine identifies a second element and a second output associated with the second element based at least in part on receiving the first media content as the input;
the second element occludes at least a portion of the first element such that the second output occludes at least a portion of the first output; and
the artificial intelligence engine generates the second media to include the first output having a first shape that accommodates a second shape of the second output.

11. The computer-implemented method of claim 1, wherein the artificial intelligence engine is trained to be specific to the video game application.

12. The computer-implemented method of claim 1, further comprising:
receiving gameplay data of the user playing the video game application with the second media content; and
further training the artificial intelligence engine based on the gameplay data.

13. The computer-implemented method of claim 1, wherein the accessibility status includes at least one of vision impairment, hearing loss, haptic sensitivity, or motion sensitivity.

14. One or more non-transitory computer-readable media comprising computer-executable instructions that, when executed by one or more processors, cause the one or more processors to perform operations comprising:
determining, based at least in part on an execution of a video game application, a first media content of the video game application to be presented at a user interface to a user;
causing, while the execution of the video game application continues, a second media content to be generated based on an accessibility status of the user, wherein:
an artificial intelligence engine generates the second media content in real-time relative to the execution of the video game application based at least in part on the artificial intelligence engine receiving at least a portion of the first media content as an input; and
the artificial intelligence engine is trained to generate the second media content based at least in part on accessibility information associated with one or more accessibility statuses; and
causing the second media content to be outputted in lieu of the first media content at the user interface.

15. The one or more non-transitory computer-readable media of claim 14, the operations further comprise causing, while the execution of the video game application continues, a first element and a first output associated with first element to be identified, wherein:
the artificial intelligence engine identifies the first element and the first output based at least in part on receiving the first media content as the input; and
the artificial intelligence engine generates the second media content based at least in part on the first element and the first output identified by the artificial intelligence engine.

16. The one or more non-transitory computer-readable media of claim 15, wherein the artificial intelligence engine generates the second media content by at least one of modifying the first output or generating an accessibility output to be included in the second media content.

17. The one or more non-transitory computer-readable media of claim 15, wherein:
the first output includes at least one of a visual output, audio output, haptic output, or motion output; and
the first element includes at least one of a character, object, gameplay effect, menu, or text.

18. A system comprising:
a memory comprising computer-executable instructions; and
a processor configured to access the memory and execute the computer-executable instructions to at least:
determine, based at least in part on an execution of a video game application, a first media content of the video game application to be presented at a user interface to a user;
cause, while the execution of the video game application continues, a second media content to be generated based on an accessibility status of the user, wherein:
an artificial intelligence engine generates the second media content in real-time relative to the execution of the video game application based at least in part on the artificial intelligence engine receiving at least a portion of the first media content as an input; and
the artificial intelligence engine is trained to generate the second media content based at least in part on accessibility information associated with one or more accessibility statuses; and
cause the second media content to be outputted in lieu of the first media content at the user interface.

19. The system of claim 18, wherein the computer-executable instructions further comprise causing, while the execution of the video game application continues, a first element and a first output associated with first element to be identified, wherein:
the artificial intelligence engine identifies the first element and the first output based at least in part on receiving the first media content as the input; and
the artificial intelligence engine generates the second media content based at least in part on the first element and the first output identified by the artificial intelligence engine.

20. The system of claim 19, wherein the artificial intelligence engine generates the second media content by at least one of modifying the first output or generating an accessibility output to be included in the second media content.
